(19) United States
(12) Patent Application Publication
(10) Pub. No.: US 2006/0235551 A1
(43) Pub. Date: Oct. 19, 2006

(54) Data storage device with audio capability

(75) Inventors: Aik Hee Goh, Singapore (SG); Susimin Suprapmo, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd.

(21) Appl. No.: 11/105,875

(22) Filed: Apr. 13, 2005

(51) Int. Cl. G06F 17/00

(52) U.S. Cl. 700/94

(57) ABSTRACT

A data storage device with audio capability. The data storage device comprises a non-volatile memory for storage of data and a decoder for decoding audio data stored in the non-volatile memory to enable playback of the audio data. A control connection is for receiving control commands from a separate host device for controlling playback of the audio data by the decoder, an audio output is to provide decoded audio data from the decoder to the separate host device, and a power connection is to receive power from the separate host device.

### FIELD OF THE INVENTION

This invention relates to a data storage device with audio capability and refers particularly, through not exclusively, to a portable data storage device with a non-volatile memory able to be used for storage of audio to be reproduced using a host.

### BACKGROUND OF THE INVENTION

There are many known, portable data storage devices using non-volatile memory for the storage of the data. Examples of the non-volatile memory used include flash memory, and miniature hard drives. However, such devices cannot be used for audio.

There are also many, known portable audio storage and playing devices such as, for example MP3 players. Whenever such devices are to be used for audio reproduction, they are used in conjunction with headphones, powered speakers, or the like. If used with a host for the reproduction to take place, the host must have a compatible audio processing system for decoding and reproduction to take place. Examples of such hosts include: computers with sound systems, speakers with built in amplifiers, and so forth. It is not possible to use the device with a host that does not have a compatible audio processing system, including decoding.

### SUMMARY OF THE INVENTION

In accordance with a first preferred aspect there is provided a data storage device with audio capability. The data storage device comprises a non-volatile memory for storage of data and a decoder for decoding audio data stored in the non-volatile memory to enable playback of the audio data. A control connection is for receiving control commands from a separate host device for controlling playback of the audio data by the decoder, an audio output is to provide decoded audio data from the decoder to the separate host device, and a power connection is to receive power from the separate host device.

The data storage device may further comprise a serial bridge for providing data transfer between the non-volatile memory and an external device. The decoder and the serial bridge may be provided in a single application-specific integrated circuit. The serial bridge may be for transferring data from an external device to the non-volatile memory over a separate data connection.

According to another aspect there is provided a method of playing back audio data stored on a data storage device. The method comprises plugging the data storage device into a host device, receiving power at the data storage device from the host device, and receiving playback control signals at the data storage device from the host device. The audio data in the data storage device is decoded to provide decoded audio data. The decoded audio data is provided from the data storage device to the host device.

According to a further aspect there is provided an audio playback device comprising a host device and a removable data storage device. The host device comprises audio playback controls for providing control commands for the playback of audio, a control connector for providing output of the control commands, and an audio input for receiving decoded audio data. The removable data storage device comprises a non-volatile memory for storage of data, a decoder for decoding audio data stored in the non-volatile memory to enable playback of the audio data, a control connection to receive control commands from the host device for controlling playback of the audio data by the decoder, an audio output to provide decoded audio data from the decoder to the host device; and a power connection to receive power from the separate host device.

For all aspects the host device may be one of: headphones, earphones, and a powered speaker unit. The removable storage device may further comprise a data connection for transferring data between the non-volatile memory and an external device. The data connection may be a USB data connection, an IEEE 1394 data connection, a male connector for insertion into a data socket of the host device, a male USB or IEEE 1394 connector. The decoded audio data may comprise an analog audio signal or a digital bitstream. The digital bitstream may be suitable as input to a digital amplifier.

The control connection and the power connection may be provided as a unitary connection or as separate connections.

The data storage device may further comprise a plurality of elongate grooves in an outer surface of the data storage device, the control connection being located in at least one first groove of the plurality of grooves, the audio output being at least one audio connection located in at least one second groove of the plurality of grooves, and the power connection being located in at least one third groove of the plurality of grooves.

The plurality of grooves may extend for the length of the outer surface, the control connection extending for a part of the length of the at least one first groove, the audio connection comprising at least one contact pin in the at least one second groove, and the power connection extending for at least a part of the at least one third groove. Preferably, the power connection extends for the full length of the at least one third groove.

The separate host device may comprise a plurality of contacts each for extending into one of the plurality of grooves for conductive contact with the control connection, the audio output, and the power connection.

The data storage device may further comprise a keyway extending longitudinally of the data storage device for ensuring correct orientation of the data storage device relative to the separate host device.

The control connection and the audio connection may extend from a first end of the data storage device.

### BRIEF DESCRIPTION OF THE DRAWINGS

In order that the present invention may be fully understood and readily put into practical effect, there shall now be described by way of non-limitative example only preferred embodiments of the present invention, the description being with reference to the accompanying illustrative drawings in which:

FIG. 1 is a perspective view of first embodiment;

FIG. 2 is a block diagram of the architecture of the first embodiment;

FIG. 3 is block diagram of the first embodiment relative to a host;

FIG. 4 is a schematic view of the first embodiment used with a first host;

FIG. 5 is a schematic view of the first embodiment used with a second host;

FIG. 6 is a schematic view of the first embodiment for use with a third host;

FIG. 7 is a schematic view of the first embodiment for use with a fourth host;

FIG. 8 is a perspective view of a second embodiment;

FIG. 9 is a top view of the second embodiment;

FIG. 10 is a front view of the second embodiment;

FIG. 11 is a rear view of the second embodiment;

FIG. 12 is a side view of the second embodiment;

FIG. 13 is an enlarged perspective view of the latch of the second embodiment; and

FIG. 14 is a flow chart of the operation of a third embodiment.

### DETAILED DESCRIPTION OF THE PREFERRED EMBODIMENTS

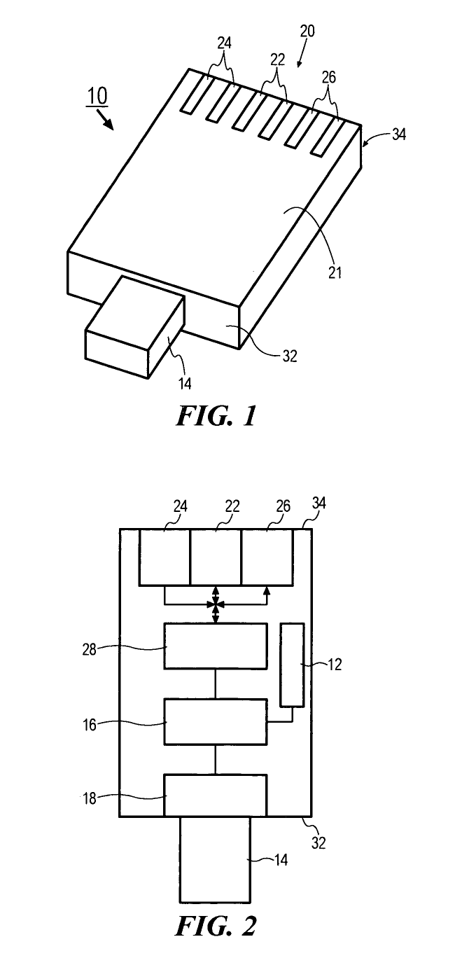

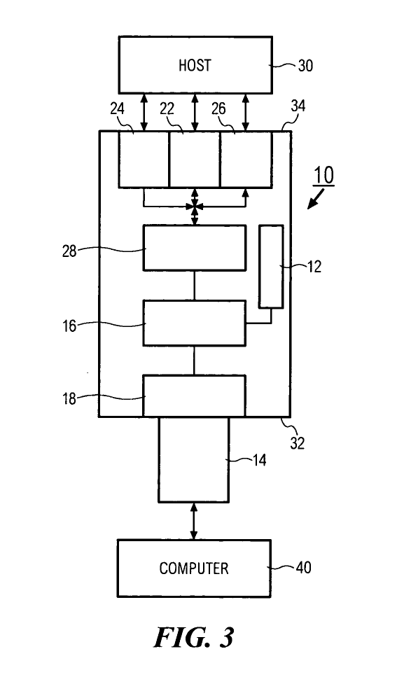

To first refer to FIG. 1 to 3, there is shown a portable storage device 10 having a non-volatile memory 12. As shown, the memory 12 may be flash memory, or a mini hard disk. A controller 16 is also provided.

The device 10 uses a male terminal 14 at a first end 32 of device 10 to connect with a corresponding port (not shown) on a host computer 40. Host computer 40 may include a display device on which menu items may be displayed. The male terminal 14 may be, for example, a USB terminal or an IEEE 1394 terminal, and the port will be a data socket. An appropriate interface for male terminal 14 is provided. Digital data can be downloaded to device 10 from computer 40 using male terminal 14, and unloaded from device 10 to computer 40 using male terminal 14. The downloading and uploading is controlled by controller 16. The digital data is stored by non-volatile memory 12.

Device 10 also has an audio connector 20 remote from male terminal 14. Preferably, male terminal 14 is at the first end 32 of device 10, and connector 20 is on or in a top surface 21 of device 10 at or adjacent the second end 34 of top surface 21, the second end being remote from male terminal 14. Connector 20 may be of any suitable type of connector able to convey audio signals, power, as well as control signals. For example, they may be finger connectors (as shown), or stripline connectors, centreline connectors, card edge connectors, drawer connectors, pin and socket connectors, keyboard connectors, spring probe connectors, and a finger-latching connectors. As shown, the connector 20 includes connections 22 for power (one of which is ground), audio in and out connections 24, and control in and out connections 26. The number of audio connections 24 may be as required or desired.

The connections 24 are operatively connected to an application specific integrated circuit 28 that contains an audio coder/decoder such as, for example, an MP3 coder/decoder, digital/analog converters, as well as a serial bridge for transferring audio between memory 12 and an external host 30. The serial bridge may use the control connections 28 for such a transfer, or may use a separate connection. Audio input through connections 24 can be encoded, and stored in memory 12 via controller 16. Also, audio stored in memory 12 can be reproduced by host 30 via controller 16 and ASIC 28 with its coder/decoder and digital/analog converter when device 10 is operatively connected to host 30. As can be seen, for this embodiment, when loading or reproducing audio all power for device 10 is from host 30, and all control signals for the controlling of the audio input to and output (including playback) from device 10 is from host 30. Alternatively or additionally, the output to host 30 from device 10 through connections 24 may be digital, and host 30 may have the digital/analog converter. This may facilitate the streaming of the audio from device 10 to host 30 as a bitstream.

Due to their physical separation, the male terminal 14 and the connector 20 may not be used at the one time.

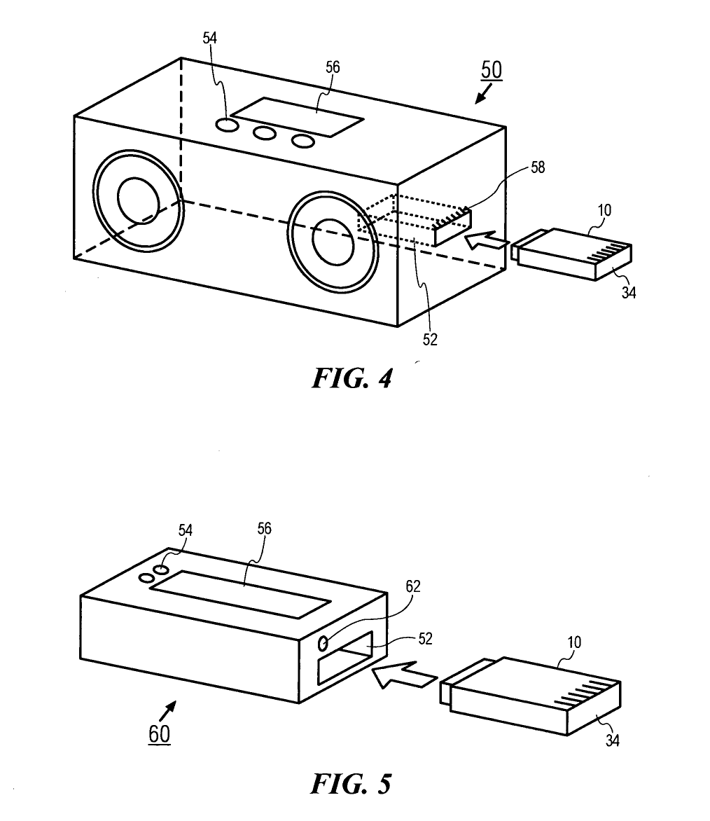

FIG. 4 shows the embodiment of FIG. 1 to 3 used with a first host 50. The host 50 is a powered speaker unit with a built-in amplifier. If audio from device 10 is as a bitstream, the amplifier may be a digital amplifier. It has a receptacle 52 for receiving device 10 by device 10 being plugged into receptacle 52, buttons 54 for controlling functions of the host and the device 10 to enable the reproduction or playback of audio from device 10, and a display 56 for displaying various reproduction functions such as for example, track, volume, equalization setting, and so forth. The control may be of analog audio and digital domain signal manipulation and processing. The receptacle 52 has corresponding connections 58 for engaging connections 22, 24, 26 to supply power to device 10, to receive audio from device 10, and for sending control signals or instructions to device 10. There is no data port corresponding to male connector 14. All audio is sent from device 10 to host 50 using connections 24, 58. The audio is sent from device 10 after being decoded by the decoder in ASIC 28. Preferably, the audio is also converted to analog before being sent to host 50. In this way, host 50 does not require a digital-to-analog converter. Thus any form of device 10 can be used, and any form of coder/decoder used in device 10. As long as connections 24, 58 are compatible, device 10 can be used with host 50 for host 50 to reproduce the stored audio. In this embodiment, the device 10 is not able to be used to reproduce stored audio when separate from the host 50 as the device 10 does not have the necessary audio functionality and circuitry (for example, amplifiers and controls) nor any inherent audio reproduction system (for example, loud speaker and/or headphone/earphone jack). Upon such functionality, circuitry and audio reproduction systems being included, the device 10 may be used to reproduce audio.

FIG. 5 shows the device 10 when used with a second host 60, in this case a portable audio player. A headphone jack 62 is provided to enable a user to listen to the audio. Receptacle 52, control buttons 54 and display 56 are also provided as before, as are connections 58 (not shown). In all other respects the operation of host 60 with device 10 is the same as for the embodiment of FIG. 4.

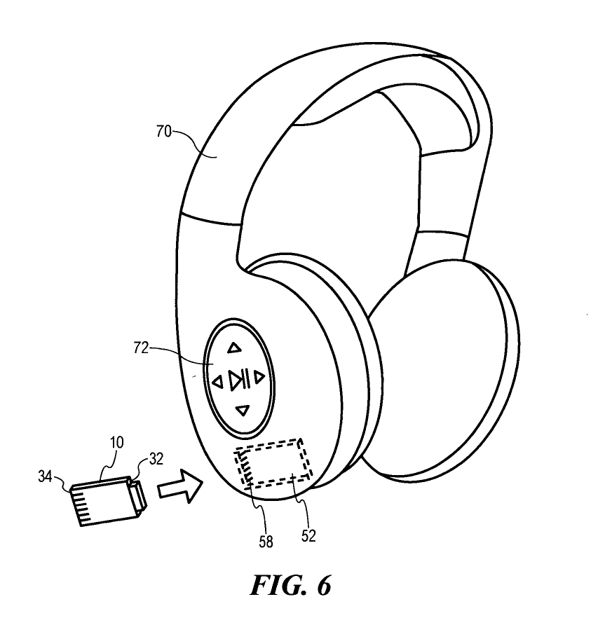

FIG. 6 illustrates a pair of headphones 70 that are the host. A receptacle 52 with connections 58 is provided. The headphones 70 have controls 72 for controlling the reproduction of the audio stored in device 10. In all other respect the operation of host 70 with device 10 is the same as for the embodiments of FIGS. 4 and 5.

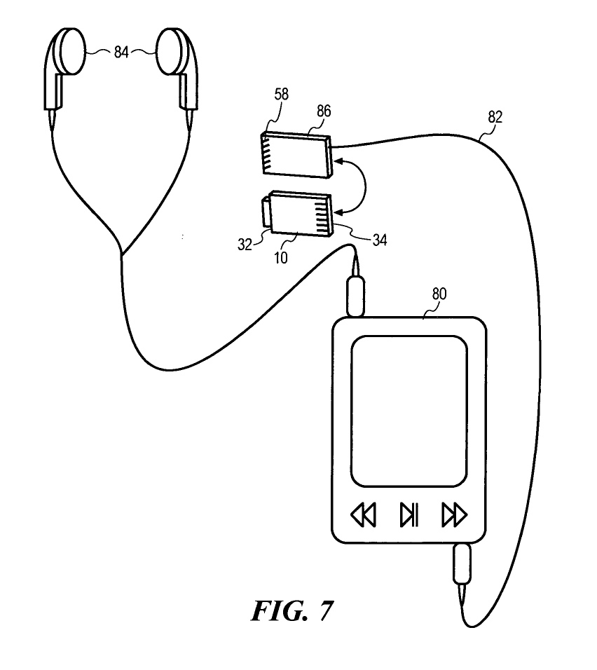

FIG. 7 shows a fourth host 80, in this case of different form of portable audio player that uses earphones 84 for audio reproduction. However, the receptacle for device 10 is not built-in. A cable 82 operatively connected to player 80 has a connector block 86 at an outer end. The connector block 86 has a connector 58 for operative engagement with connections 22, 24, 26. Connector block 86 may be a socket, a clip to mount on device 10, or otherwise as required or desired.

Modulation of power supplied to device 10 from the host may be used to provide control signals to device 10 from the host. Therefore, the control connections 26 and power connection 22 may be provided as a unitary connection.

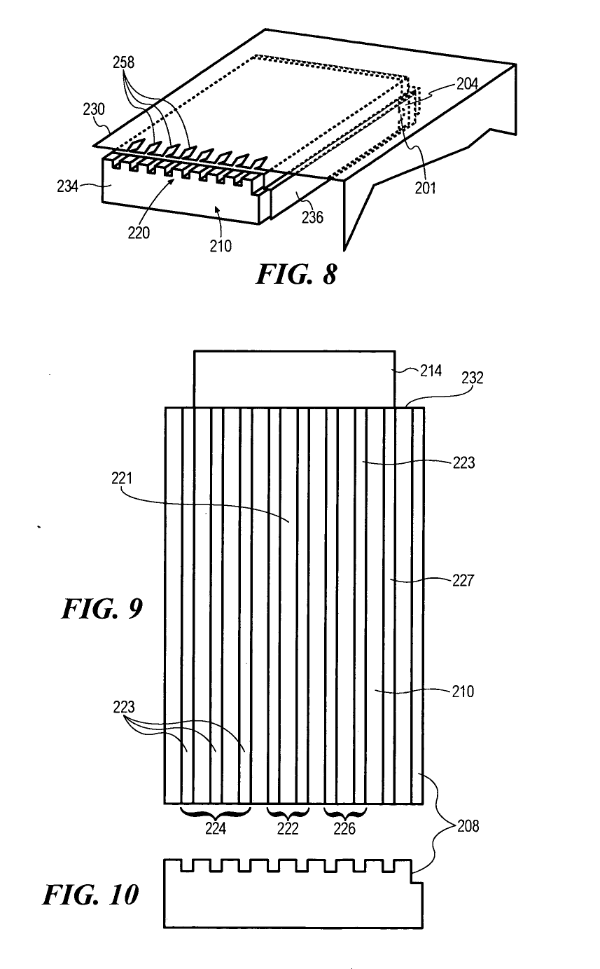

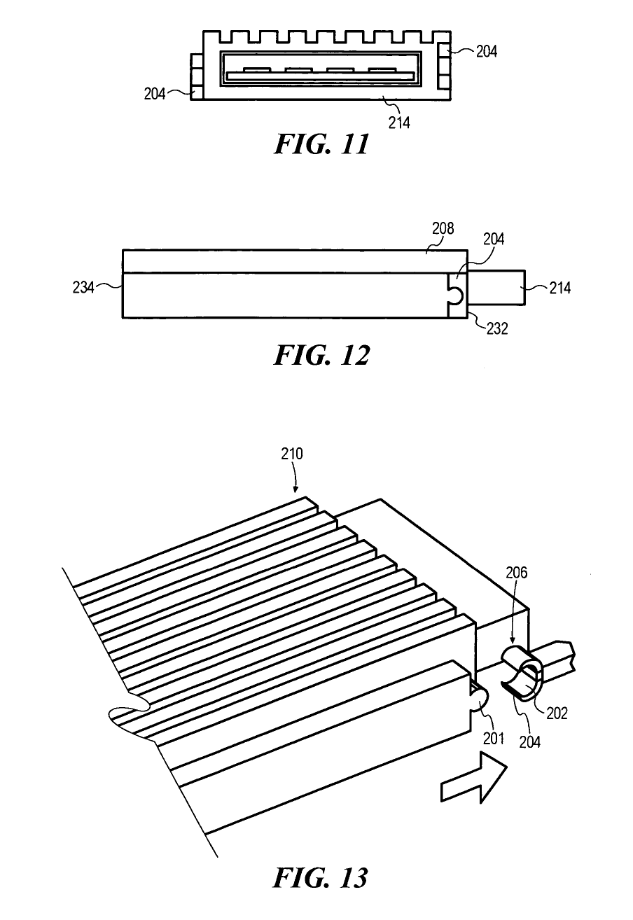

The second embodiment is illustrated in FIGS. 8 to 13. In the second embodiment like components have like reference numerals but with a prefix number 2. The principal difference of the second embodiment over the first embodiment is in the connector 220 of the device 210. Here, the connector 220 comprises connection 222 for power, audio in and out connections 224, and control in and out connections 226.

Each of the connections 222, 224 and 226 is located within an elongate groove 223 in an extending along the top surface 221 of device 210. The grooves 223 are generally U-shaped, although other shapes such as, for example, V-shaped, may be used. The connections 222, 224 and 226 are formed on the walls of grooves 223 including one or more of: a side wall, both side walls, and base and thus are generally of the same shape as the grooves. The connections 222, 224 and 226 may extend for the full length of the grooves 223, or a part of the length of the grooves 223. Preferably, the power connections 222 extend for the full length of the grooves 223, the control connections 226 extend for part only of the grooves 223, and the audio connection 224 may be contact pins 225 only. The control connections 226 may extend from the second end 234.

The contact pins 225 are at or adjacent the second end 234 and extend inwardly from one or both side walls of grooves 223.

The host 230 includes a plurality of contacts 258 that extend downwardly to engage connections 222, 224 and 226 in grooves 223. The contacts 258 may be pins of any suitable shape or size; or may be blades, as shown. If the contacts 258 are blades, they should be sized and shaped to be able to enter grooves 223 and make electrical contact with connections 222, 224 and 226; as well as being able to connect with contact pins 225. The contacts 258 for audio connections 224 locate at least in part between contact pins 225 to provide good electrical contact for audio transfer. The contact pins 225 may be integral or may be separate components. The contact pins 225 may be of any suitable shape, and may extend laterally into the grooves 223 by any required amount provided the audio contacts 258 make a proper connection therewith.

In this way contacts 258 will pass along a substantial part of the length of each connection 222, 224 and 226 thus providing a self-cleaning action each time the device 210 is inserted and each time the device 210 removed. This cleaning is enhanced due to the contacts 258 engaging the connections 222, 224 and 226 as they commence insertion. Furthermore, as connections 222, 224 and 226 are preferably located wholly within the grooves 223 (i.e. do not extend beyond the boundaries of grooves 223) they should be beyond being able to be touched by a user. Thus surface contamination of connections 222, 224 and 226, due to skin oil and perspiration will be reduced.

The device 210 is also provided with a keyway 208 to assist in accurately locating device 210 in host 230, and to assist in device 210 being correctly oriented relative to host 230 before being inserted into host 230. The keyway 208 is preferably at a junction of top surface 221 and a side wall 236 of device 210 so as to not interfere with connections 222, 224 and 226. Alternatively, or additionally, one or more of the grooves 223 may be shaped as an inverted “L” or “T” to provide a keyway effect. Any corresponding contact 258 would be correspondingly shaped.

However, the keyway 208 may be at any other suitable location such as for example, a junction of a side and the base of device 210, on the base of device 210, or in a side of device 210.

Preferably there is provided a latch 206. Preferably, latch 206 is a spring-loading latch of the well known “press to insert; press to release” form. Such a latch is shown in FIGS. 8, 11 and 12, and in an alternative form in FIG. 13. The latch 206 has a catch 204 with a concave recess 202 that may be generally considered as approximating the shape of a major segment of a circle. However, it may be of any other suitable shape. The catch 204 is adapted to releasably receive therein a pin 201. The catch 204 is in two halves that close on pin 201 when pin 201 is inserted. A repeated inwards push will cause catch 204 to open to enable pin 201 to be released.

The catch 204 may be on either or both sides of the device 210 with one or two pins 201 in host 230 (FIGS. 8, 11 and 12); or the catch(es) 204 may be in host 230 and the device 210 may have the pin(s) 201 (FIG. 13).

The initial push and then release to engage catch 204 and pin 201 causes contact pins 225 to move relative to contacts 258 for audio connections 222. This relative movement of contacts 258 between contact pins 225 provides a further cleaning action of contacts 258 and contact pins 225 during both insertion and removal of device 210.

One groove 227 may not have a connector and may be reserved for a possible special connection (not shown). The number of grooves 223 should be at least the same as the number of connectors 222, 224 and 226, and the number of contacts 258 should be the same as the total number of connectors 222, 224 and 226.

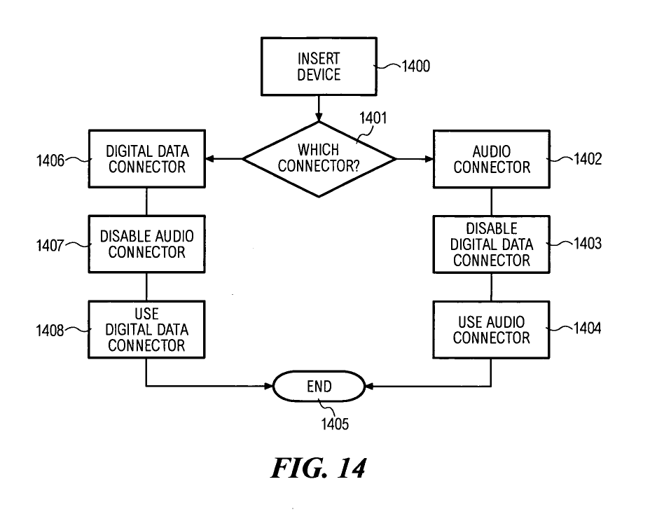

As stated above, connector 20, 220 and male terminal 14, 214 may not be used at the same time due to their physical separation. Additionally or alternatively, the prevention of the connector 20, 220 and the male terminal 14, 214 being used at the same time may be by an electronic interface, or by operation of the operating system of controller 16. The last case is illustrated in FIG. 14. Here, the controller 16 will perform a sub-routine, as illustrated. Upon the device 10, 210 being inserted into host 30 (or computer/external device 40), 230 (1400), the controller queries (1401) which connector is being used. This may be by determining the source of the power and/or control signals, or otherwise as required. If it is the audio connections 58, 258 (1402) the digital data connector 14, 214 is disabled (1403) and the audio connector 20, 220 is used (1404). The sub-routine ends (1405). If it is the digital data connector 14, 214 (1406) the audio connection 20, 220 is disabled (1407) and the digital data connector 14, 214 is used (1408). The sub-routine ends (1405).

Whilst there has been described in the foregoing description preferred embodiments of the present invention, it will be understood by those skilled in the technology concerned that many variations or modifications in details of design or construction may be made without departing from the present invention,

1. A data storage device with audio capability, the data storage device comprising:
(a) non-volatile memory for storage of data;
(b) a decoder for decoding audio data stored in the non-volatile memory to enable playback of the audio data;
(c) a control connection for receiving control commands from a separate host device for controlling playback of the audio data by the decoder;
(d) an audio output for providing decoded audio data from the decoder to the separate host device;
(e) a power connection for receiving power from the separate host device;
(f) the control connection, audio output and power connection comprising an audio connector; and
(g) a data connection for transferring data between the non-volatile memory and an external device, the data connection being remote from the audio connector.

2. The data storage device of claim 1, wherein the data connection comprises a connector for insertion into a data socket of the external device,

3. The data storage device as claimed in claim 2, wherein the data connection is at a first end of the device, and the audio connector is adjacent a second end of the device, the data connection comprising a USB data connection or an IEEE 1394 data connection.

4. The data storage device of claim 1, further comprising a serial bridge for providing data transfer between the non-volatile memory and an external device, the decoder and the serial bridge being provided in a single application-specific integrated circuit.

5. The data storage device of claim 4, wherein the serial bridge transfers data from an external device to the non-volatile memory over a data connection.

6. The data storage device of claim 1, wherein the decoded audio data comprises an analog audio signal.

7. The data storage device as claimed in claim 1 further comprising a plurality of elongate grooves in an outer surface of the data storage device, the control connection being located in at least one first groove of the plurality of grooves, the audio output being at least one audio connection located in at least one second groove of the plurality of grooves, and the power connection being located in at least one third groove of the plurality of grooves.

8. The data storage device as claimed in claim 7, wherein the plurality of grooves extend for the length of the outer surface and the control connection extends for a part of the length of the at least one first groove, the at least one audio connection comprising at least one contact pin in the at least one second groove, and the power connection extends for at least a part of the at least one third groove.

9. The data storage device claimed in claim 7, wherein the power connection extends for the full length of the at least one third groove.

10. The data storage device as claimed in claim 7, wherein the separate host device comprises a plurality of contacts each for extending into one of the plurality of grooves for conductive contact with the control connection, the audio connection, and the power connection.

11. The data storage device claimed in claim 1, further comprising a keyway extending longitudinally of the data storage device for ensuring correct orientation of the data storage device relative to the separate host device.

12. A method of playing back audio data stored on a data storage device, the data storage device comprising an audio connector and a data connection remote from the audio connector, the method comprising:
(a) plugging the data storage device into a host device;
(b) receiving power at the data storage device from the host device;
(c) determining which of the audio connector and data connection of the data storage device is being used;
(d) if the audio connector is being used, receiving playback control signals at the data storage device from the host device;
(e) decoding the audio data in the data storage device to provide decoded audio data; and
(f) providing the decoded audio data from the data storage device to the host device.

13. The method of claim 12, wherein the decoded audio data is one of: an analog audio signal and a digital bitstream.

14. An audio playback device comprising:
a host device comprising:
(a) audio playback controls for providing control commands for the playback of audio;
(b) a control connector for providing output of the control commands;
(c) an audio input for receiving decoded audio data; and
a removable data storage device comprising:
(a) non-volatile memory for storage of data;
(b) a decoder for decoding audio data stored in the non-volatile memory to enable playback of the audio data;
(c) a control connection to receive control commands from the host device for controlling playback of the audio data by the decoder
(d) an audio output to provide decoded audio data from the decoder to the host device;
(e) a power connection to receive power from the separate host device;
(f) the control connection, audio output and power connection comprising an audio connector; and
(g) a data connection for transferring data between the non-volatile memory and an external device, the data connection being remote from the audio connector.

15. The audio playback device of claim 14, wherein the host device is selected from the group comprising headphones, earphones and a powered speaker unit.

16. The audio playback device of claim 14, wherein the data connection is for transferring data between the non-volatile memory and an external device, the data connection being a USB data connection or an IEEE 1394 data connection.

17. The audio playback device of claim 16, wherein the data connection comprises a connector for insertion into a data socket of the host device.

18. The audio playback device of claim 14, wherein the control connection and the power connection are provided as a unitary connection.

19. The audio playback device of claim 14, wherein the control connection and the power connection are provided as separate connections.

20. The audio playback device as claimed in claim 14 further comprising a plurality of elongate grooves in an outer surface of the data storage device, the control connection being located in at least one first groove of the plurality of grooves, the audio output being at least one audio connection located in at least one second groove of the plurality of grooves, and the power connection being located in at least one third groove of the plurality of grooves.

21. The audio playback device is claimed in claim 20, wherein the audio output comprises at least one contact pin adjacent a second end of the data storage device, the control connection extending for a part of the length of the at least one first groove and the power connection extending for at least a part of the at least one third groove.

22. The audio playback device as claimed in claim 20, wherein the plurality of grooves extend for the length of the outer surface.

23. The audio playback device as claimed in claim 20, wherein the separate host device comprises a plurality of contacts each for extending into one of the plurality of grooves for conductive contact with the control connection, the audio connection, and the power connection.

24. The audio playback device claimed in claim 14, further comprising a keyway extending longitudinally of the data storage device for ensuring correct orientation of the data storage device relative to the separate host device.

25. The audio playback device as claimed in claim 14, wherein the control connection and the power connection extend from a second end of the data storage device.

26. The audio playback device as claimed in claim 17, wherein the data connection, and the control connection, the audio output and the power connection, are not able to be used at the same time.

27. The data storage device as claimed in claim 17, wherein the audio connector and the data connector are not able to be used at the same time.
